(19) United States
(12) Patent Application Publication
(10) Pub. No.: US 2005/0184678 A1
(43) Pub. Date: Aug. 25, 2005

(54) Starting device for a high-pressure discharge lamp, and an illuminating system

(76) Inventors: Arnulf Rupp, Taufkirchen (DE); Wolfram Sowa, Munchen (DE)

Correspondence Address: OSRAM SYLVANIA INC, 100 ENDICOTT STREET, DANVERS, MA, 01923, US

(21) Appl. No.: 10/876,555

(22) Filed: Jun. 28, 2004

(30) Foreign Application Priority Data
Jul. 10, 2003 (DE) 10331435.0

(51) Int. Cl. H05B 39/00

(52) U.S. Cl. 315/209 PZ; 315/244; 315/276

(57) ABSTRACT

The invention relates to a starting device for a high-pressure discharge lamp having a piezoelectric transformer for generating the starting voltage required for starting the gas discharge in the high-pressure discharge lamp.

### I. TECHNICAL FIELD

The invention relates to a starting device for a high-pressure discharge lamp and to an illuminating system having a high-pressure discharge lamp as well as an operating circuit and a starting device for the high-pressure discharge lamp.

### II. BACKGROUND ART

Laid-open specification WO 00/59270 A1 describes a starting and operating circuit for a high-pressure discharge lamp that is equipped with a piezoelectric transformer. The starting voltage required for starting the gas discharge in the high-pressure discharge lamp is generated with the aid of a voltage multiplier that amplifies the output voltage on the secondary side of the piezoelectric transformer in an appropriate fashion.

### III. DISCLOSURE OF THE INVENTION

It is the object of the invention to provide an improved starting device for a high-pressure discharge lamp.

This object is achieved by a starting device for a high-pressure discharge lamp, wherein the starting device has a piezoelectric transformer for generating the starting voltage required for starting the gas discharge in the high-pressure discharge lamp. Particularly advantageous designs of the invention are described in the dependent claims.

The starting device according to the invention has a piezoelectric transformer for generating the starting voltage required for starting the gas discharge in the high-pressure discharge lamp. That is to say, the piezoelectric transformer is designed according to the invention as a starting transformer that generates on its secondary side a voltage sufficient for starting the gas discharge, when it is fed on the primary side with a supply voltage whose frequency is tuned to a resonant frequency of the piezoelectric transformer.

The piezoelectric transformer of the starting device according to the invention is preferably designed in such a way that it has an input region with first terminals for supplying it with voltage, and an output region with second electric terminals for providing the starting voltage for the high-pressure discharge lamp. The input region or/and the output region of the piezoelectric transformer advantageously have sections that can be mutually inversely polarized in order to ensure the largest possible transformation ratio. The transformation ratio of the piezoelectric transformer is the ratio of the output voltage to the input voltage of the piezoelectric transformer. In accordance with a preferred exemplary embodiment of the invention, the starting device has a resonant circuit whose voltage output is connected to the first terminals of the piezoelectric transformer and whose resonant frequency is tuned to the resonant frequency of the piezoelectric transformer in order to ensure optimum excitation of the resonant oscillation of the piezoelectric transformer only during the starting phase of the lamp.

The illuminating system according to the invention comprises a high-pressure discharge lamp, an operating circuit and a starting device for the high-pressure discharge lamp. According to the invention, the starting device has a piezoelectric transformer for generating the starting voltage required for starting the gas discharge in the high-pressure discharge lamp. As has already been explained above, the piezoelectric transformer is designed as a starting transformer that directly generates the starting voltage for the high-pressure discharge lamp.

The piezoelectric transformer of the illuminating system according to the invention has an input region that is provided with first electric terminals for supplying voltage to the piezoelectric transformer, and an output region that is equipped with second electric terminals, at least one second electric terminal being connected to an electrode of the high-pressure discharge lamp in order to provide the starting voltage for the high-pressure discharge lamp. The electrode is preferably an auxiliary starting electrode of the high-pressure discharge lamp that couples the starting energy capacitively into the discharge medium. The piezoelectric transformer is thereby not loaded on the output side, and a high transformation ratio is thus permitted. In accordance with a preferred exemplary embodiment of the invention, the illuminating system is equipped with a resonant circuit whose voltage input is connected to the voltage output of the operating circuit and whose voltage output is connected to the first terminals, the resonant frequency of the resonant circuit being tuned to a resonant frequency of the piezoelectric transformer. Consequently, it is possible during the starting phase of the high-pressure discharge lamp to achieve optimum excitation of the resonant oscillation of the piezoelectric transformer, and it is further ensured that the resonant oscillation of the piezoelectric transformer is no longer excited when, after being started, the lamp is operated with a voltage of another frequency that is at a satisfactory spacing from the resonant frequency of the piezoelectric transformer.

### IV. BRIEF DESCRIPTION OF THE DRAWINGS

The invention is explained below in more detail with the aid of two preferred exemplary embodiments. In the drawing:

FIG. 1 shows a schematic of the illuminating system in accordance with the first exemplary embodiment of the invention, and

FIG. 2 shows a schematic of the illuminating system in accordance with the second exemplary embodiment of the invention.

### V. BEST MODE FOR CARRYING OUT THE INVENTION

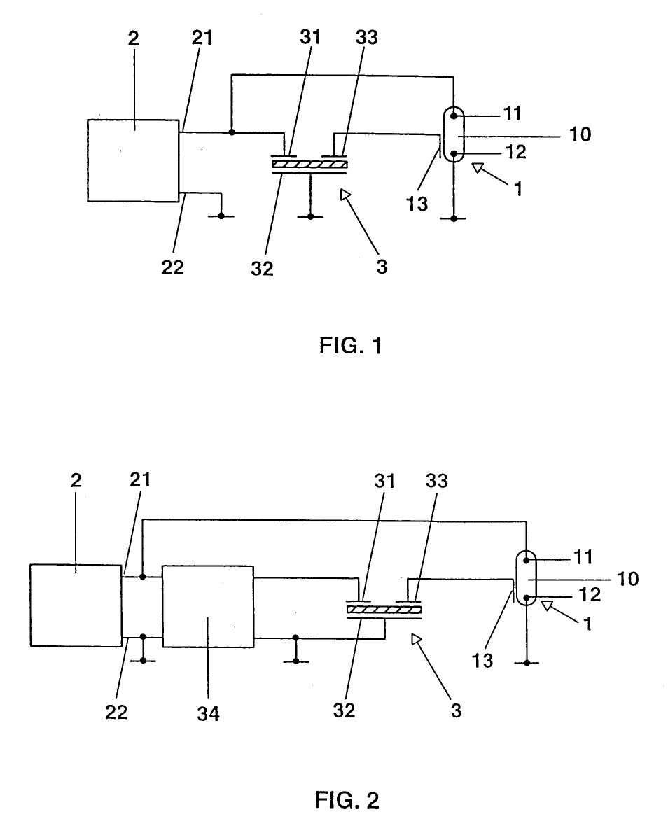

The illuminating system, depicted schematically in FIG. 1, in accordance with the first exemplary embodiment is a motor vehicle headlamp that comprises a metal halide high-pressure discharge lamp 1, an operating circuit 2 and a starting device 3 for the metal halide high-pressure discharge lamp 1. This lamp 1 serves as the light source of the motor vehicle headlamp, for example for producing the passing beam or/and the main light. The metal halide high-pressure discharge lamp 1 has two electrodes 11, 12 between which a gas discharge is formed in the discharge medium 10 during operation of the lamp.

Moreover, the metal halide high-pressure discharge lamp 1 has an auxiliary starting electrode 13 that is designed, for example, as an electrically conducting coating on the lamp vessel and permits the starting voltage to be coupled capacitively into the discharge medium 10. The operating circuit 2 serves to supply the metal halide high-pressure discharge lamp 1 with voltage after the gas discharge has been started in the discharge medium 10. The operating circuit 2 is designed essentially as a voltage transformer that transforms the motor vehicle network voltage of, for example 12 volts or 24 volts DC to the radio-frequency arc voltage of the metal halide high-pressure discharge lamp 1 in the voltage range from approximately 40 volts to 200 volts and in the frequency range from approximately 0.1 MHz to 1 MHz. The voltage transformer can comprise, for example, a push-pull inverter, a full-bridge inverter or a half-bridge inverter. A first output terminal 21 of the operating circuit is connected to the first electrode 11 of the metal halide high-pressure discharge lamp 1 in order to apply the latter with the radio-frequency arc voltage of the lamp 1. The second output terminal 22 of the operating circuit 2 is connected to the ground potential. The second electrode 12 of the metal halide high-pressure discharge lamp 1 is also likewise connected to the ground potential. The starting device 3 comprises a piezoelectric transformer that generates the starting voltage of up to 30 kilovolts required for starting the gas discharge in the discharge medium 10. For this purpose, the piezoelectric transformer 3 has an input region with first electric terminals 31, 32 for supplying it with voltage, and an output region with second electric terminals 32, 33 at which the output voltage of the piezoelectric transformer 3 is provided. The electric terminal 32, which is assigned both to the input region and to the output region of the piezo-electric transformer 3, is at ground potential. The first electric terminal 31 is connected to the radio-frequency voltage output 21 of the operating circuit 2, while the second electric terminal 33 of the piezo-electric transformer 3 is connected to the auxiliary starting electrode 13 of the metal halide high-pressure discharge lamp 1. The input region and the output region of the piezoelectric transformer 3 have a number of neighboring, mutually inversely polarizable sections which renders possible a transformation ratio of the transformer 3 comprising several powers of ten. Such a piezoelectric transformer 3 is described, for example, in laid-open specification DE 101 09 994 A1. The resonant frequencies of the piezoelectric transformer 3 that can be excited are a function of its dimensions and its shape. They are in the frequency range of approximately 0.1 MHz to 1 MHz.

During the starting phase of the metal halide high-pressure discharge lamp 1, the electric terminals 31, 32 of the input region of the piezoelectric transformer 3 are fed by the operating circuit 2 with a radio-frequency voltage whose frequency is tuned to a resonant frequency of the piezoelectric transformer 3. Consequently, the starting voltage of up to 30 kilovolts required for starting the gas discharge in the discharge medium 10 of the lamp 1 is provided on the output side at the electric terminals 32, 33 of the piezoelectric transformer 3. This starting voltage is fed to the auxiliary starting electrode 13 of the lamp 1 and coupled capacitively into the discharge medium 10. After the gas discharge has been started in the discharge medium, the lamp 1 and the starting device 3 are supplied by the operating circuit 2 with a radio-frequency voltage whose frequency is at a satisfactory spacing from the resonant frequency of the piezoelectric transformer 3 such that the latter is no longer excited during the lit operation of the lamp 1.

The second exemplary embodiment, depicted in FIG. 2, of the illuminating system according to the invention differs from the above-described first exemplary embodiment only by an additional resonant circuit 34 that is designed as a component of the starting device and is connected upstream of the piezoelectric transformer 3. The first and second exemplary embodiments agree in all other details. Consequently, the same reference numerals have also been used in FIGS. 1 and 2 for identical parts of the two exemplary embodiments. The first electric terminals 31, 32 of the input region of the piezoelectric transformer 3 are connected via the resonant circuit 34 to the output terminals 21, 22 of the operating circuit. The resonant circuit 34 essentially comprises inductive and capacitive components. Its resonant frequency is tuned to a resonant frequency of the piezoelectric transformer 3. The resonant circuit 34 ensures that during the lit operation of the metal halide high-pressure discharge lamp, that is to say after the gas discharge has been started in the discharge medium 10 of the lamp 1, the piezoelectric transformer 3 is not excited when the operating circuit 2 provides at its terminals 21, 22 a radio-frequency, non-sinusoidal operating voltage whose frequency does not correspond to the resonant frequency of the piezoelectric transformer 3. The piezoelectric transformer 3 generates the starting voltage for the lamp 1 at its terminals 32, 33 only during the starting phase of the lamp 1, during which the operating circuit provides at the output terminals 21, 22 a radio-frequency voltage tuned to the resonant frequency of the piezoelectric transformer 3 and of the resonant circuit 24.

1. A starting device for a high-pressure discharge lamp, wherein the starting device has a piezoelectric transformer for generating the starting voltage required for starting the gas discharge in the high-pressure discharge lamp.

2. The starting device as claimed in claim 1, wherein the piezoelectric transformer has an input region with first terminals for supplying voltage to the piezoelectric transformer, and an output region with second electric terminals for providing the starting voltage for the high-pressure discharge lamp.

3. The starting device as claimed in claim 2, wherein the starting device has a resonant circuit whose voltage output is connected to the first terminals and whose resonant frequency is tuned to a resonant frequency of the piezoelectric transformer.

4. The starting device as claimed in claim 2, wherein the input region or/and the output region of the piezoelectric transformer has a number of neighboring, mutually inversely polarizable sections.

5. An illuminating system having a high-pressure discharge lamp, an operating circuit and a starting device for said high-pressure discharge lamp, wherein said starting device has a piezoelectric transformer for generating the starting voltage required for starting the gas discharge in the high-pressure discharge lamp.

6. The illuminating system as claimed in claim 5, wherein the piezoelectric transformer has an input region with first terminals that serve to supply voltage to the piezoelectric transformer, and an output region with second electric terminals, at least one second electric terminal being connected to an electrode of the high-pressure discharge lamp for providing the starting voltage.

7. The illuminating system as claimed in claim 6, wherein the electrode is an auxiliary starting electrode.

8. The illuminating system as claimed in claim 6, wherein the illuminating system has a resonant circuit whose voltage input is connected to the voltage output of the operating circuit and whose voltage output is connected to the first terminals, the resonant frequency of the resonant circuit being tuned to a resonant frequency of the piezoelectric transformer.
